(19) United States
(12) Patent Application Publication
(10) Pub. No.: US 2016/0351991 A1
(43) Pub. Date: Dec. 1, 2016

(54) NFC Antenna Structure

(71) Applicants: Yongli Chen, Shenzhen (CN); Meng Li, Shenzhen (CN)

(72) Inventors: Yongli Chen, Shenzhen (CN); Meng Li, Shenzhen (CN)

(73) Assignee: AAC Technologies Pte. Ltd., Singapore city (SG)

(21) Appl. No.: 15/001,961

(22) Filed: Jan. 20, 2016

(30) Foreign Application Priority Data
Jun. 1, 2015 (CN) 201510293959.3

(51) Int. Cl. H01Q 1/12; H01Q 7/00; H04B 5/00

(52) U.S. Cl. CPC H01Q 1/12; H04B 5/0081; H01Q 7/00

(57) ABSTRACT

An NFC antenna structure is disclosed in the present disclosure. The NFC antenna structure includes a metal back cover including a side frame, and including a plurality of through-holes; a NFC coil positioned below the metal back cover. The NFC coil is located at least partially in a normal projection area of the through-holes, and the side frame is provided with a plurality of slits communicating with the through-holes.

### FIELD OF THE INVENTION

The present invention discloses a mobile phone antenna, particular to an NFC antenna structure.

### DESCRIPTION OF RELATED ART

With progressive development of mobile phone, ipad and other mobile device, the requirement on the appearance of mobile terminal devices is increasingly high. Mobile terminals with metal housing, because of good texture and wear resistance, are favored by the majority of consumers.

NFC (Near Filed Communication) function of the existing mobile terminal is accomplished by attaching an NFC coil on a plastic rear cover to radiate signals, or opening a hole on the metal back cover and affixing NFC coil on the hole position to radiate signals. But, the plastic back cover cannot meet the development needs of mobile terminals anymore, and radiation efficiency is not very high.

Therefore, it is necessary to provide a new NFC antenna structure to overcome the problems mentioned above.

### BRIEF DESCRIPTION OF THE DRAWINGS

Many aspects of the embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is structural diagram of an NFC antenna structure in accordance with an exemplary embodiment of the present disclosure.

### DETAILED DESCRIPTION OF THE EXEMPLARY EMBODIMENT

The present invention will hereinafter be described in detail with reference to an exemplary embodiment. To make the technical problems to be solved, technical solutions and beneficial effects of present disclosure more apparent, the present disclosure is described in further detail together with the figures and the embodiment. It should be understood the specific embodiment described hereby is only to explain this disclosure, not intended to limit this disclosure.

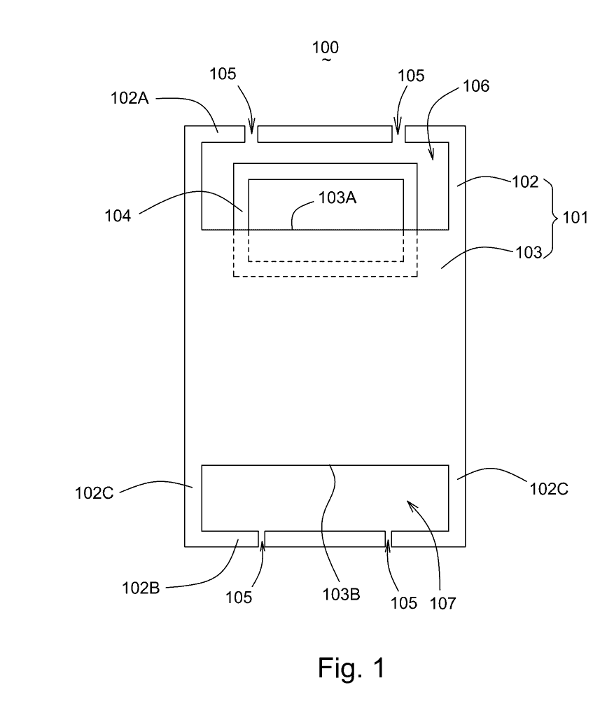

As shown in FIG. 1, an NFC antenna structure 100, in accordance with an exemplary embodiment of the present disclosure, includes a metal back cover 101 and an NFC coil 104 located beneath the metal back cover 101.

The metal rear cover 101 includes a side frame 102 and a main body 103 located inside the side frame 102. The side frame 102 is a rectangular frame, includes a first short edge 102A, a second short edge 102B parallel to the first short edge 102A, and two long edges 102C connected with the first short edge 102A and the second short edge 102B. The main body 103 is located in the side frame 102 and connected with two long edges 102C. The main body 103 is provided with a first side edge 103A relative to the first short edge 102A and a second side edge 103B relative to the second short edge 102B. The first side edge 103A and the second side edge 103B make the main body 103 shorter than the side frame 102 in the length direction.

The side frame 102 is provided with two through-holes, i.e. a first through-hole 106 and a second through-hole 107. The first through-hole 106 is formed by the first short edge 102A, two long edges 102C and the first side edge 103A. The second through-hole is formed by the second short edge 102B, two long edges 102C and the second side edge 103B. The NFC coil 104 is located at least partially within the normal projection area of the first through-hole 106. In other words, the whole NFC coil 104 can also be located within the normal projection area of the first through-hole 106. The first through-hole 106 will not block off the radiated signals emitted from NFC coil.

The first short edge 102A and the second short edge 102B are provided respectively with two slits 105. Two slits 105 are separated in parallel. Extending direction of the slits 105 is perpendicular to a extending direction of the first short edge 102A and the second short edge 102B. The slits 105 can emit more efficiently the radiated signals of NFC coil 104, improve the radiation performance of NFC antenna.

It is to be understood, however, that even though numerous characteristics and advantages of the present embodiment have been set forth in the foregoing description, together with details of the structures and functions of the embodiment, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An NFC antenna structure including:
a metal back cover including a side frame, and including a plurality of through-holes;
a NFC coil positioned below the metal back cover; wherein
the NFC coil is located at least partially in a normal projection area of the through-holes, and the side frame is provided with a plurality of slits communicating with the through-holes.

2. The NFC antenna structure as described in claim 1, wherein the side frame includes a first short edge and a second short edge faced each other, and two long edges connecting the first short edge to the second short edge, the metal back cover includes a main body located in the side frame and connected with the long edge, the main body includes a first side edge and a second side edge which are faced respectively to the first short edge and the second short edge.

3. The NFC antenna structure as described in claim 2, wherein the through-holes includes a first through-hole formed by the first short edge, two long edges and the first side edge, and a second through-hole formed by the second short edge, two long edges and the second side edge.

4. The NFC antenna structure as described in claim 3, wherein four slits are provided and are located respectively on the first short edge and the second short edge, an extending direction of the slits is perpendicular to a length direction of the first short edge and the second short edge.
